(19) United States
(12) Patent Application Publication
(10) Pub. No.: US 2026/0127884 A1
(43) Pub. Date: May 7, 2026

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Koichi SATO, Kanagawa (JP)

(73) Assignee: FUJIFILM Business Innovation Corp., Tokyo (JP)

(21) Appl. No.: 19/204,833

(22) Filed: May 12, 2025

(30) Foreign Application Priority Data
Nov. 5, 2024 (JP) 2024-193399

(51) Int. Cl. G06V 20/52; G06F 21/62; G06V 10/34; G06V 40/10; G10L 13/02; H04N 7/18

(52) U.S. Cl. CPC G06V 20/52; G06F 21/6245; G06V 10/34; G06V 40/10; G10L 13/02; H04N 7/183

(57) ABSTRACT

An information processing system includes a processor configured to: determine a scope of disclosure that determines to what extent personally identifiable information is to be included in information extracted from a captured image, according to a personal information protection level, which depends on an installation location of a camera that continuously captures images of a preset location, and an urgency of an emergency situation that has occurred; and transmit, to an external device, information extracted from an image captured by the camera with personally identifiable information included according to the determined scope of disclosure.

### CROSS-REFERENCE TO RELATED APPLICATIONS

This application is based on and claims priority under 35 USC 119 from Japanese Patent Application No. 2024-193399 filed Nov. 5, 2024.

### BACKGROUND

(i) Technical Field
The present disclosure relates to an information processing system, an information processing method, and a non-transitory computer readable medium.
(ii) Related Art

Japanese Unexamined Patent Application Publication No. 2002-142214 discloses a video monitoring system configured to identify a personal portion in a captured image of a monitored person, composite an abstracted image of the identified personal portion with the original image, and transmit the composite image, thereby making it possible to monitor activity of the person while protecting the person's privacy.

Japanese Unexamined Patent Application Publication No. 2023-006192 discloses a position information system capable of protecting privacy at normal times while also allowing for information about all portable terminals to be displayed in the event of an emergency.

### SUMMARY

In recent years, network cameras are being used for applications such as detecting congestion conditions in restaurants, monitoring unmanned payment stores, detecting intruders for crime prevention, and detecting persons experiencing a fall or accident. Such network cameras are installed at preset locations and are configured to continuously transmit captured images to an external server. Furthermore, recent years have seen proposals for endpoint cameras that transmit image data scrubbed of privacy information to an external device when an image of a person is included in an image captured by performing image analysis involving artificial intelligence (AI) processing on the camera side.

However, an issue with such endpoint cameras is that if captured images are always scrubbed of privacy information before being transmitted to an external destination, and an emergency situation such as a disaster or an accident occurs, the obtained information may be inadequate and not allow for a rapid response. On the other hand, with such endpoint cameras, if captured images are not always scrubbed of privacy information before being transmitted to an external destination, the divulging of privacy information is a concern, and personal privacy may not be protected to a sufficient degree.

Aspects of non-limiting embodiments of the present disclosure relate to both protecting personal information and facilitating response in the event of an emergency situation in a configuration whereby information extracted from images continuously captured by a camera installed at a preset location is transferred to an external destination, even if the captured images contain images of persons.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: determine a scope of disclosure that determines to what extent personally identifiable information is to be included in information extracted from a captured image, according to a personal information protection level, which depends on an installation location of a camera that continuously captures images of a preset location, and an urgency of an emergency situation that has occurred; and transmit, to an external device, information extracted from an image captured by the camera with personally identifiable information included according to the determined scope of disclosure.

### BRIEF DESCRIPTION OF THE DRAWINGS

Exemplary embodiments of the present disclosure will be described in detail based on the following figures, wherein:

FIG. 1 is a diagram illustrating a system configuration of an information processing system according to an exemplary embodiment of the present disclosure;

FIG. 2 is a block diagram illustrating a hardware configuration of a camera 10 according to an exemplary embodiment of the present disclosure;

FIG. 3 is a block diagram illustrating a functional configuration of a camera 10 according to an exemplary embodiment of the present disclosure;

FIG. 4 is a diagram illustrating an example of an urgency table stored in table information storage 34;

FIG. 5 is a diagram illustrating an example of a privacy consideration table stored in table information storage 34;

FIG. 6 is a diagram illustrating an example of a metadata generation policy table stored in table information storage 34;

FIG. 7 is a diagram illustrating an example of a metadata content determination table stored in table information storage 34;

FIG. 8 is a diagram for explaining a specific example of metadata generated by a metadata generator 36;

FIG. 9 is a flowchart illustrating overall operations by an information processing system according to an exemplary embodiment of the present disclosure;

FIG. 10 is a diagram illustrating how metadata is generated on the basis of urgency and the installation location of a camera 10;

FIG. 11 is a diagram illustrating a hardware configuration of a camera 10A, which is an exemplary modification of an exemplary embodiment of the present disclosure;

FIG. 12 is a diagram illustrating a functional configuration of a camera 10A, which is an exemplary modification of an exemplary embodiment of the present disclosure; and

FIG. 13 is a flowchart illustrating overall operations by an information processing system in an exemplary modification of an exemplary embodiment of the present disclosure.

### DETAILED DESCRIPTION

The following describes exemplary embodiments of the present disclosure in detail with reference to the drawings.

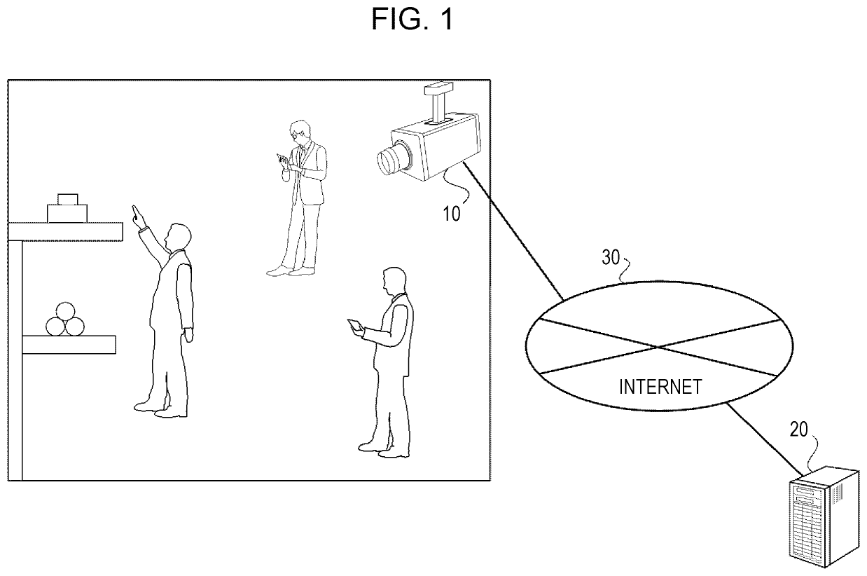

FIG. 1 is a diagram illustrating a system configuration of an information processing system according to an exemplary embodiment of the present disclosure.

As illustrated in FIG. 1, the information processing system according to an exemplary embodiment of the present disclosure is formed from a camera 10 installed in a certain space to be monitored and a management server 20 connected with the camera 10 via a network such as the Internet 30.

The camera 10 is installed in a space to be monitored, which may be a shop, an office, a factory, a hospital, or a nursing home, for example. The camera 10 is used for applications such as detecting congestion conditions in the space where the camera 10 is installed, monitoring an unmanned payment store, detecting intruders for crime prevention, and detecting persons experiencing a fall or accident.

The camera 10 is what is called an endpoint camera, and is configured to perform image analysis involving artificial intelligence (AI) processing on a captured image and transmit, to the management server 20, metadata in which the captured image has been scrubbed of privacy information. The camera 10 is installed at a preset location, continuously captures images of the space to be monitored, and transfers information extracted from the captured images to an external device, namely the management server 20.

The management server 20 monitors the space where the camera 10 is installed by receiving, from the camera 10 via the Internet 30, metadata that has been scrubbed of privacy information.

However, an issue with the camera 10 is that if information in which captured images are always scrubbed of privacy information is transmitted to the management server 20, and an emergency situation such as a disaster or an accident occurs, the obtained information may be inadequate and not allow for a rapid response on the management server 20 side.

Accordingly, in an information processing system according to the exemplary embodiment, control is carried out as described below to both protect personal information and facilitate response in the event of an emergency situation, even if the captured images contain images of persons.

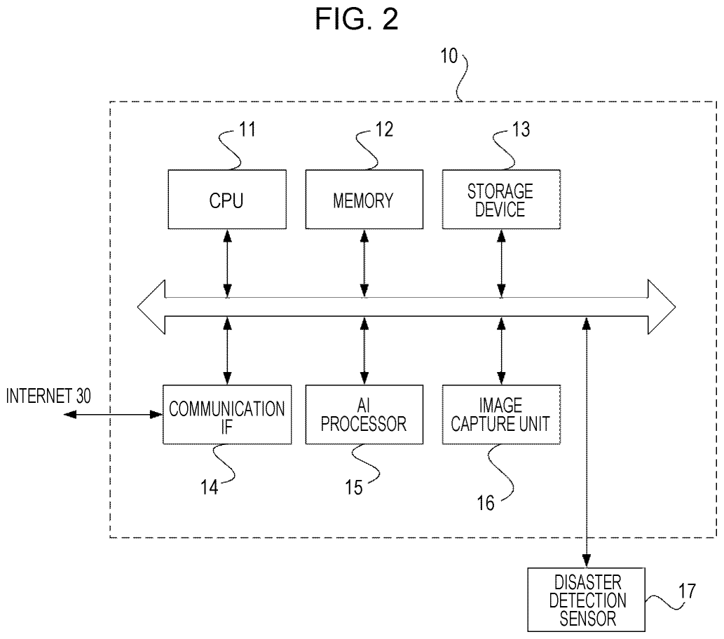

Next, a hardware configuration of the camera 10 in the information processing system according to the exemplary embodiment is illustrated in FIG. 2.

As illustrated in FIG. 2, the camera 10 includes a CPU 11, a memory 12, a storage device 13 such as flash memory, a communication interface (abbreviated as IF) 14 that transmits and receives data to and from an external device or the like via a network such as the Internet 30, an AI processor 15, and an image capture unit 16. These components are interconnected through a control bus.

The CPU 11 is a processor that controls operations by the camera 10 by executing predetermined processing on the basis of a control program stored in the memory 12 or the storage device 13. Note that although the CPU 11 is described as reading out and executing a control program stored in the memory 12 or the storage device 13 in the exemplary embodiment, the control program is not limited thereto. The control program may also be provided by being recorded onto a computer readable recording medium. For example, the program may be provided by being recorded on an optical disc, such as a Compact Disc Read-Only Memory (CD-ROM) or a Digital Versatile Disc-Read-Only Memory (DVD-ROM), or by being recorded on a semiconductor memory, such as Universal Serial Bus (USB) memory or a memory card. The control program may also be acquired from an external device over a communication channel connected to the communication interface 14. Furthermore, for example, the control program may be provided as standalone application software, or the program may be incorporated into the software of each device as a function of the camera 10.

The image capture unit 16 continuously captures images of the space to be monitored by using an image sensor such as a charge-coupled device (CCD) sensor or a complementary metal-oxide-semiconductor (CMOS) sensor. In this context, continuously capturing images means both capturing a moving image and capturing still images at fixed intervals.

The AI processor 15 is a processor that executes AI image analysis involving a neural network on the images captured by the image capture unit 16. The AI processor 15 uses any of various AI models to recognize an object included in an image, identify a person by face recognition, detect the pose of a person by skeletal estimation, and the like. Specifically, the AI processor 15 may recognize an object using an object detection algorithm such as YOLO as the AI model, and detect the pose of a person using a skeletal estimation algorithm such as HRNet, for example.

The CPU 11 is also notified of a detection result regarding the detection of an earthquake, fire, or other disaster from a disaster detection sensor 17 provided outside the camera 10. The disaster detection sensor 17 is an earthquake sensor and a fire sensor, for example, and detects that a fire and/or an earthquake has occurred in the space to be monitored.

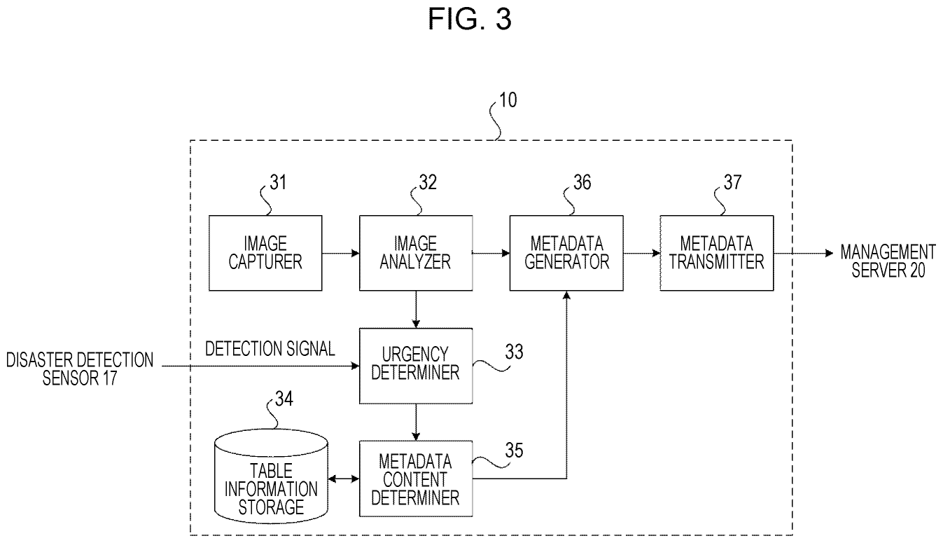

FIG. 3 is a block diagram illustrating a functional configuration of the camera 10 achieved by executing the above control program.

As illustrated in FIG. 3, the camera 10 according to the exemplary embodiment is provided with an image capturer 31, an image analyzer 32, an urgency determiner 33, table information storage 34, a metadata content determiner 35, a metadata generator 36, and a metadata transmitter 37.

The image capturer 31 is formed by the image capture unit 16 described above and continuously captures images of a preset location to be monitored.

The image analyzer 32 is formed by the AI processor 15 described above, and executes image analysis processing such as object detection and skeletal estimation of persons on images captured by the image capturer 31.

When an emergency situation such as an earthquake or a fire occurs, the urgency determiner 33 determines the urgency of the emergency situation that has occurred. Specifically, the urgency determiner 33 determines the urgency of the emergency situation that has occurred on the basis of the results of analysis by the image analyzer 32 and a disaster detection result from the disaster detection sensor 17. The emergency situation may be not only a disaster such as an earthquake or a fire, but may also include a fall or the like by a person in the space to be monitored. The urgency is determined in four stages from level 0 to level 3, for example. Details of the urgency will be described later. Note that when the occurrence of a disaster such as a fire or an earthquake is detected, the urgency determiner 33 determines an even higher urgency if a fallen and immobilized person is additionally detected.

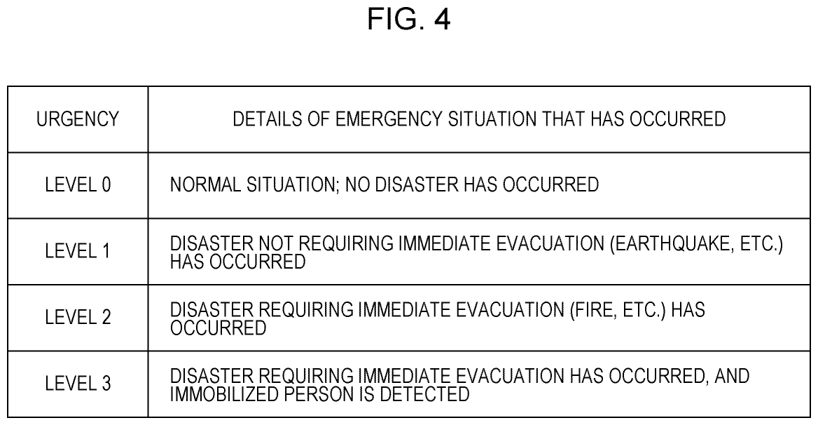

The table information storage 34 stores various table information as illustrated in FIGS. 4 to 7.

The urgency table illustrated in FIG. 4 indicates the correspondence relationship between the details of an emergency situation that has occurred and the urgency. In this example, the urgency is set in four stages from level 0 to level 3. In a normal situation in which no disaster has occurred, the urgency is set to level 0. In a situation in which a disaster not requiring immediate evacuation has occurred, the urgency is set to level 1. In a situation in which a disaster requiring immediate evacuation has occurred, the urgency is set to level 2. In a situation in which a disaster requiring immediate evacuation has occurred and an immobilized person is additionally detected, the urgency is set to level 3.

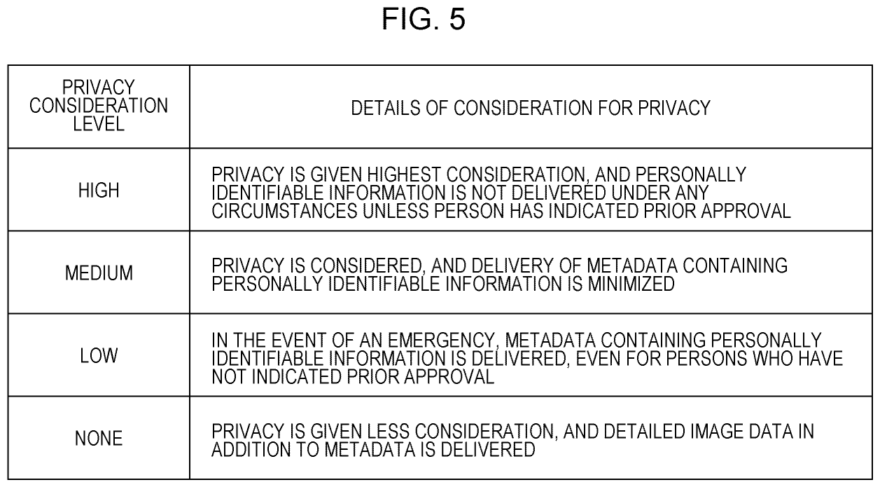

The privacy consideration level table illustrated in FIG. 5 indicates the correspondence relationship between details of consideration for privacy and a privacy consideration level. The privacy consideration level is a level of personal information protection defining the degree to which personal privacy is considered, and is set in the four stages of “high”, “medium”, “low”, and “none”. When the privacy consideration level is “high”, privacy is given the highest consideration, and personally identifiable information is not delivered under any circumstances unless a person has consented in advance. When the privacy consideration level is “medium”, privacy is considered, and delivery of metadata containing personally identifiable information is minimized. When the privacy consideration level is “low”, in the event of an emergency, metadata containing personally identifiable information is delivered, even for persons who have not consented in advance. When the privacy consideration level is “none”, privacy is given less consideration, and detailed image data in addition to metadata is delivered.

Note that a person entering or leaving the space that is subject to image capture is asked to indicate in advance whether or not the person consents to personal information being included in metadata and delivered to an external destination. Accordingly, when the urgency is level 0 in which no disaster or the like has occurred, personal information about a person who has not consented in advance is not included in the metadata delivered to an external destination.

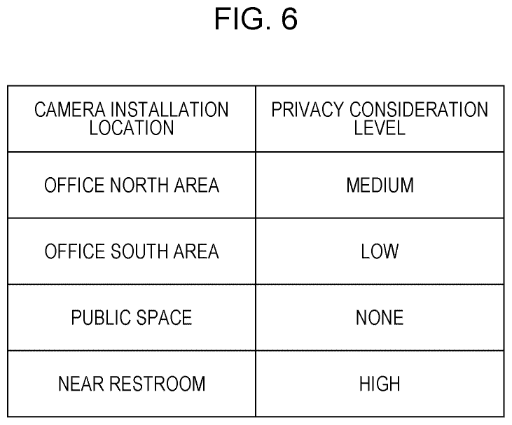

The metadata generation policy table illustrated in FIG. 6 indicates the correspondence relationship between the camera installation location and the privacy consideration level. Referring to the table illustrated in FIG. 6, when for example the camera installation location is office north area, the privacy consideration level is set to “medium”. Similarly, when the camera installation location is office south area, public space, and near restroom, the privacy consideration level is set to “low”, “none”, and “high”, respectively. In other words, the privacy consideration level is preset for each location where the camera 10 is installed, while taking into account the characteristics of the installation location.

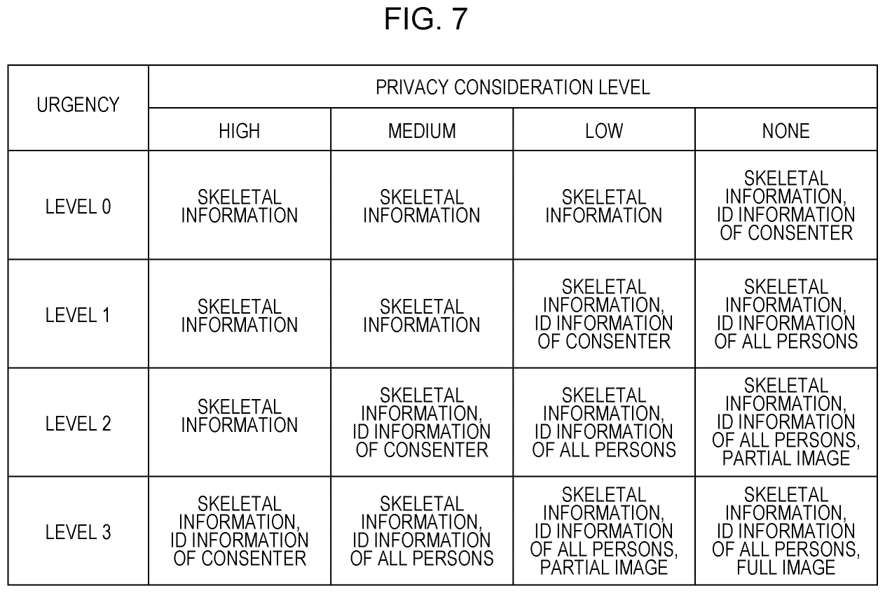

In addition, the table information storage 34 stores a metadata content determination table as illustrated in FIG. 7. In the metadata content determination table, metadata content is associated with each combination of the privacy consideration level in accordance with the camera installation location and the urgency of an emergency situation that has occurred.

In this context, metadata content specifically indicates a scope of disclosure that determines to what extent personally identifiable information is to be included in information such as metadata extracted from an image captured by the image capturer 31.

For example, referring to the determination table in FIG. 7, when the urgency is level 0 and the privacy consideration level is “low”, the metadata is set to include only skeletal information. However, if the urgency rises to level 1, the metadata is set to include skeletal information in addition to ID information of persons who have consented in advance, even when the privacy consideration level is “low”. If the urgency rises to level 2, the metadata is set to include skeletal information in addition to ID information of all persons, including those who consented in advance and those who have not, even when the privacy consideration level is “low”. If the urgency rises to level 3, the metadata is set to include skeletal information and ID information of all persons in addition to partial images of images captured by the image capturer 31, even when the privacy consideration level is “low”.

In this context, ID information of a person is information that may be used to identify that person, and means any of various information such as a name, an employee number, and an identification number, for example.

The determination table illustrated in FIG. 7 demonstrates that the higher the urgency is, the broader is set the scope of disclosure of personal information to be disclosed in the metadata, even for a camera installed at the same location, or in other words a camera with the same privacy consideration level. In other words, even if the metadata content is set such that personal information is minimally disclosed at normal times when the urgency is low, the metadata content is set such that personal information is disclosed in the metadata as the urgency rises.

Based on the privacy consideration level in accordance with the installation location of the camera 10 and the urgency of an emergency situation that has occurred, the metadata content determiner 35 determines the scope of disclosure that determines to what extent personally identifiable information is to be included in the metadata, that is, the information extracted from captured images.

The metadata content determiner 35 determines the scope of disclosure for disclosing personal information in the metadata by using the privacy consideration level in accordance with the installation location of the camera 10 and the urgency of an emergency situation that has occurred, on the basis of the determination table illustrated in FIG. 7.

Note that, as illustrated in FIG. 7, the scope of disclosure is set such that the higher the privacy consideration level, the narrower the scope of personal information to be included in the metadata extracted from an image captured by the camera 10, and the higher the urgency of the emergency situation, the broader the scope of personal information to be included in the metadata extracted from an image captured by the camera 10.

Also, the scope of disclosure is set such that, as the scope of personal information to be included in the metadata extracted from an image captured by the camera 10 gets broader, the scope of disclosure gets broader gradually in the following order: skeletal information about a person in a captured image obtained by performing skeletal estimation of that person; ID information of only persons who have consented in advance to providing personal information; and ID information of both persons who have consented in advance to providing personal information and persons who have not.

The metadata generator 36 generates metadata extracted from an image captured by the image capturer 31, with personally identifiable information included in the metadata according to the scope of disclosure determined in the metadata content determiner 35.

The metadata transmitter 37 transmits the metadata generated by the metadata generator 36 to an external device, namely the management server 20.

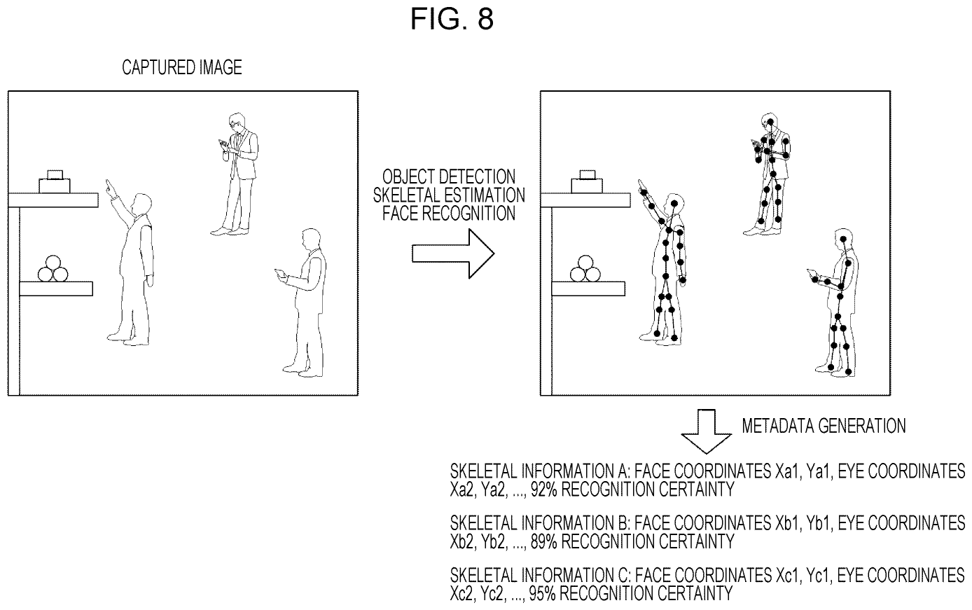

Next, a specific example of metadata generated by the metadata generator 36 will be described with reference to FIG. 8.

First, the image analyzer 32 executes image analysis such as object detection, skeletal estimation of persons, and individual identification by face recognition of persons on an image captured by the image capturer 31. On the basis of the results of the analysis by the image analyzer 32, the metadata generator 36 generates skeletal information about each person in the image, recognition angle information, and the like as metadata. Note that FIG. 8 illustrates a case in which only skeletal information is generated as metadata, without including personally identifiable information in the generated metadata. The skeletal information specifically contains coordinate information for each of the face, eyes, shoulders, hips, hands, feet, and the like of a subject person.

Note that although the exemplary embodiment describes a case in which the information to be included in the metadata is information pertaining to persons in an image, information pertaining to objects in an image may also be included as metadata.

In this way, the metadata may be structured to include information like the following.

(1) Information about objects in image
Coordinates inside space, name, recognition certainty information

(2) Skeletal information about persons in image
Coordinate points for each of face, eyes, shoulders, hips, hands, feet, and the like, recognition certainty information

(3) Personal identification information
Name of person
Image in which person is shown (image in which anyone other than subject person is concealed)

Next, operations by the information processing system according to the exemplary embodiment will be described in detail with reference to the drawings.

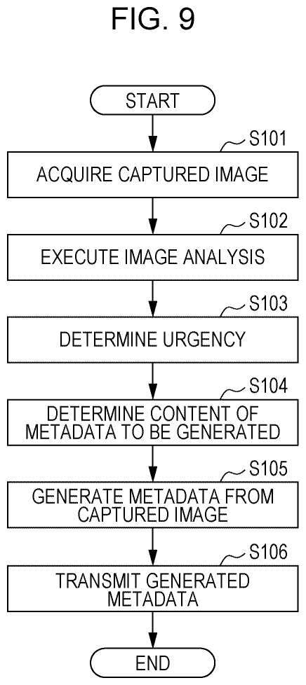

FIG. 9 is a flowchart illustrating overall operations by the information processing system according to the exemplary embodiment.

First, in step S101, the image capturer 31 captures an image of the space to be monitored. Thereafter, in step S102, the image analyzer 32 executes image analysis processing such as object detection, skeletal estimation, and face recognition on the captured image.

Next, in step S103, the urgency determiner 33 determines the current urgency and sets the level of urgency on the basis of the urgency table illustrated in FIG. 4.

Thereafter, in step S104, the metadata content determiner 35 determines the content of the metadata to be generated, according to the level of urgency set in the urgency determiner 33 and the privacy consideration level based on the location where the camera 10 is installed. For example, in the case where the installation location of the camera 10 is public space, the metadata content determiner 35 refers to the metadata generation policy table illustrated in FIG. 6 and determines “None” as the privacy consideration level. The metadata content determiner 35 then refers to the metadata content determination table illustrated in FIG. 7 and determines the content of the metadata to be generated, on the basis of the determined privacy consideration level and the level of urgency set in the urgency determiner 33.

Thereafter, in step S105, the metadata generator 36 refers to the result of the analysis by the image analyzer 32 and generates metadata on the basis of the metadata content determined by the metadata content determiner 35.

Finally, in step S106, the metadata transmitter 37 transmits the metadata generated by the metadata generator 36 to an external device such as the management server 20.

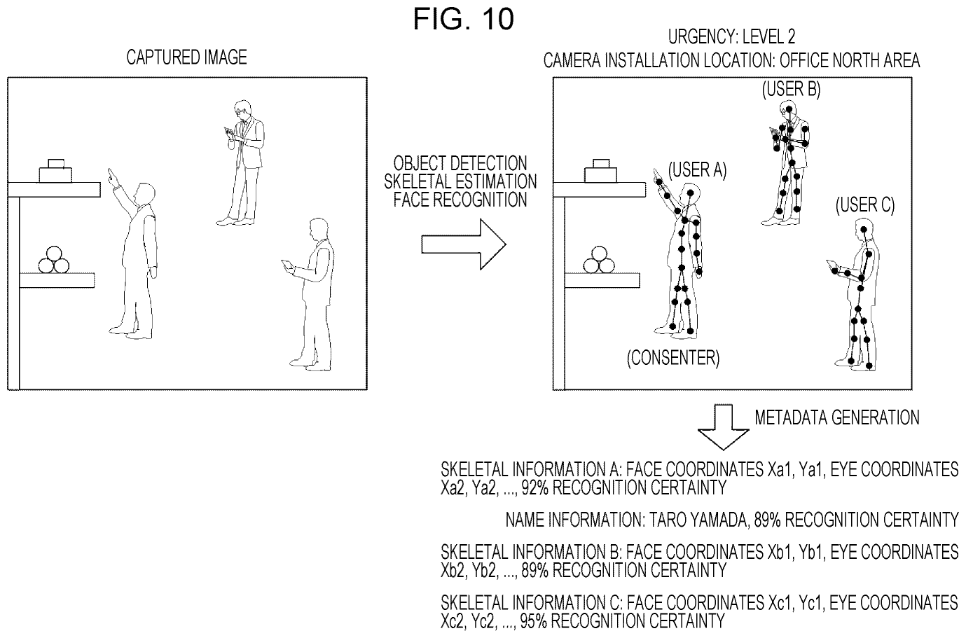

FIG. 10 illustrates how metadata is generated on the basis of urgency and the installation location of the camera 10 in this way.

FIG. 10 will be used to describe an example in which the urgency is set to level 2 and the installation location of the camera 10 is office north area. Also, in the example described below, three persons referred to as users A, B, and C are shown in a captured image, and only user A has consented to the disclosure of personal information.

In this case, since the installation location of the camera 10 is office north area, the metadata content determiner 35 determines that the privacy consideration level is “medium” according to the metadata generation policy table in FIG. 6. The metadata content determiner 35 then refers to the content determination table in FIG. 7 and determines that skeletal information and ID information of a consenter are the metadata to be generated when the privacy consideration level is “medium” and the urgency is level 2.

Accordingly, on the basis of the analysis result from the image analyzer 32, the metadata generator 36 generates metadata including skeletal information about the users A to C in the image in addition to ID information of the user A who has consented in advance to the disclosure of personal information. Referring to FIG. 10, the diagram demonstrates that the generated metadata includes the information “Taro Yamada”, which is the name of user A.

### Exemplary Modification

Next, a camera 10A will be described as an exemplary modification of the camera 10 according to the exemplary embodiment.

The information processing system according to the exemplary embodiment is assumed to be used in the event of a disaster, but it is also assumed that network or other equipment malfunctions may occur in conjunction with a disaster. If such network or other equipment malfunctions occur, it is conceivable that generated metadata may no longer be transferable to the management server 20. Accordingly, an exemplary modification of the exemplary embodiment achieves the following function: when a situation arises such that metadata is not transferable to the management server 20, a notification regarding the content of the metadata is provided to a person in the vicinity of the camera via a speech output device.

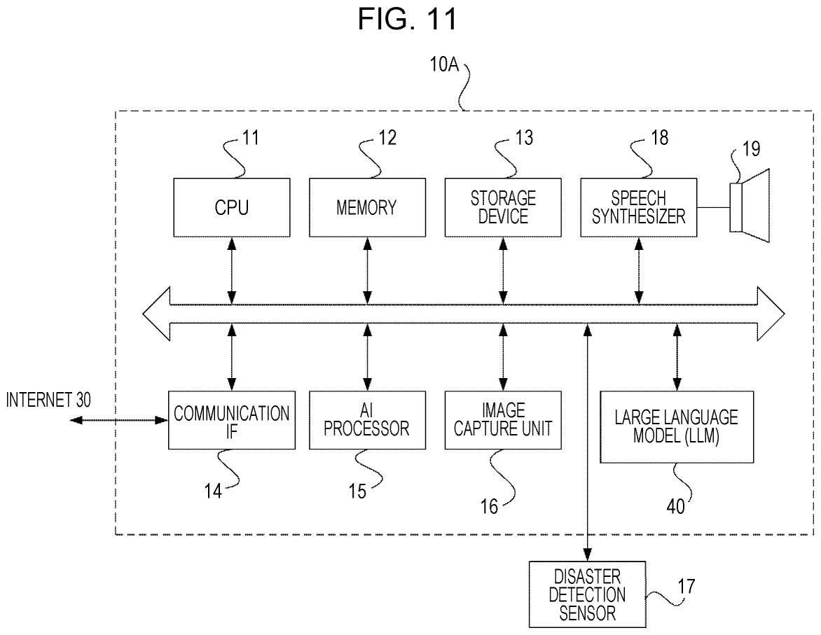

FIG. 11 illustrates a hardware configuration of the camera 10A that is an exemplary modification of the exemplary embodiment. The hardware configuration of the camera 10A illustrated in FIG. 11 is the camera 10 illustrated in FIG. 2 with the addition of a speech synthesizer 18, a speaker 19, and a large language model (hereinafter abbreviated as LLM) 40. Note that in FIG. 11, portions of the configuration that are the same as in FIG. 2 are denoted with the same signs, and description thereof is reduced or omitted.

The speech synthesizer 18 performs speech synthesis processing on the basis of generated text information to convert the text information into a speech signal. The speaker 19 outputs the speech signal generated by the speech synthesizer 18 externally as speech.

The LLM 40 has a function of converting various information, such as an inputted image and metadata, into text information and outputting the text information. For example, inputting a captured image of a person in a fallen state and metadata extracted from the image into the LLM 40 causes these pieces of information to be converted into the text information “A person has fallen.”

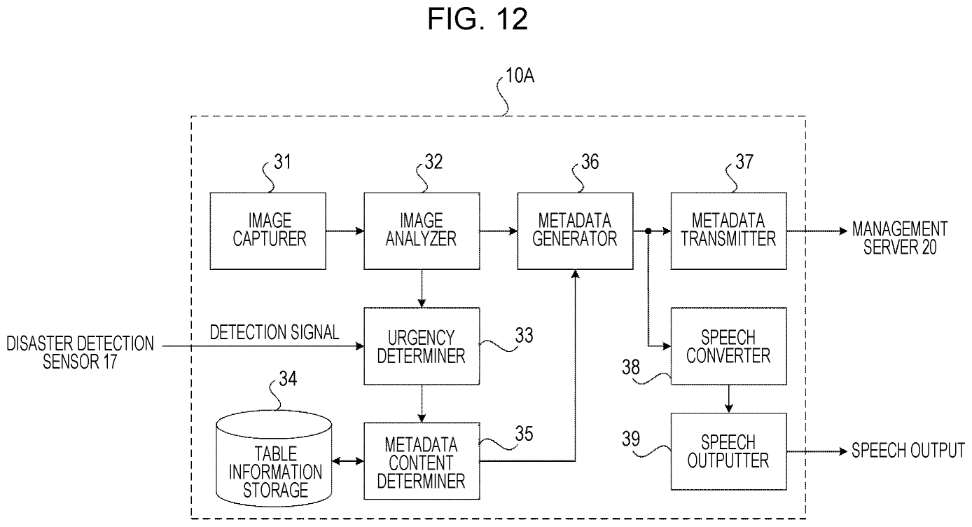

Next, FIG. 12 illustrates a functional configuration of the camera 10A that is an exemplary modification of the exemplary embodiment. The functional configuration of the camera 10A illustrated in FIG. 12 is the configuration of the camera 10 illustrated in FIG. 3 with the addition of a speech converter 38 and a speech outputter 39. Note that in FIG. 12, portions of the configuration that are the same as in FIG. 3 are denoted with the same signs, and description thereof is reduced or omitted.

If an emergency situation occurs in which metadata is not transferable to the management server 20 that is the preset destination, the speech converter 38 inputs the metadata inputted from the metadata generator 36 into the LLM 40 illustrated in FIG. 11, and thereby acquires text information pertaining to the image content of the captured image. The text information acquired by the speech converter 38 is then outputted as speech information via the speech outputter 39.

For example, if the image analyzer 32 has performed skeletal estimation of a person in an image captured by the image capturer 31 to detect whether or not the person is in an abnormal pose, and has detected an abnormal pose, such as a fall, of the person in the image, but metadata extracted from the captured image is not transferable to the preset destination, the speech converter 38 inputs into the LLM 40 the information extracted from the image in which the person is detected to be in an abnormal pose. The speech converter 38 acquires text information pertaining to the state of the person in the captured image from the LLM 40, and outputs the acquired text information as speech information via the speech outputter 39.

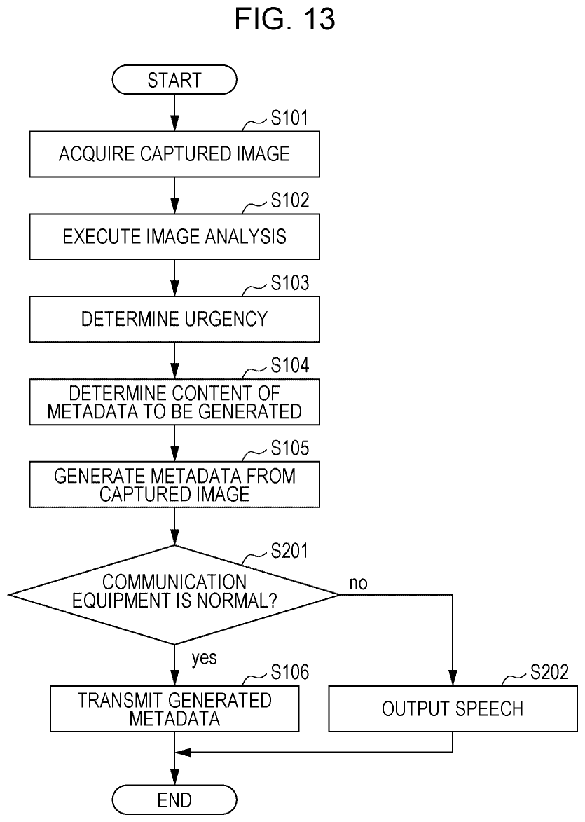

Operations in the exemplary modification of the exemplary embodiment will be described with reference to the flowchart in FIG. 13. Note that the flowchart in FIG. 13 differs from the flowchart in FIG. 9 only in the addition of the processing in steps S201 and S202. Consequently, in the description below, only the processing in steps S201 and S202 is described.

In the camera 10A according to the exemplary modification of the exemplary embodiment, in step S201, it is determined whether or not communication equipment is normal depending on whether or not metadata is transferable to the management server 20. In step S201, if the communication equipment is determined to be normal, the generated metadata is transmitted to the management server 20 by the metadata transmitter 37.

In step S201, if the communication equipment is determined not to be normal in step S201, in step S202, the generated metadata is outputted as speech by the speech converter 38 and the speech outputter 39. For example, in a case where the metadata includes information indicating the name of a consenter, speech saying “A has fallen.” is outputted to the vicinity of the camera 10A.

In the exemplary embodiment, processes are executed by a computer of any kind. The computer of any kind may execute these processes using a processor as hardware, by a program as software, or by a combination of the above. In the latter case, the processor is configured to cooperate with the program to execute various processes according to the exemplary embodiment, and may function as each unit or means according to the exemplary embodiment. The order in which operations are to be executed by the processor is not limited to the order described and may be changed, as appropriate. The computer of any kind may be a general-purpose computer, an application-specific computer, a workstation, or some other system capable of executing the processes.

The processor may be configured using one or multiple pieces of hardware, and the type of hardware is not limited. For example, the processor may be configured using hardware such as a central processing unit (CPU), a microprocessing unit (MPU), a programmable logic device such as a field-programmable gate array (FPGA), a special-purpose circuit such as an application-specific integrated circuit (ASIC) for executing specific processing, a graphics processing unit (GPU), or a neural processing unit (NPU). The type of hardware may also be a combination of different types of hardware. In the case where multiple pieces of hardware are configured to execute one or more processes of a certain processor, the multiple pieces of hardware may be present in physically discrete devices or may be present in the same device. Also, in any exemplary embodiments, the order of the processes by the processor is not limited to the order described above and may be changed, as appropriate. Note that hardware is formed from electrical circuitry or the like in which circuit elements such as semiconductor elements are combined.

Furthermore, the program may be software such as firmware or microcode. The program may also be a group of program modules, for example, each function of which may be achieved by a processor configured to execute the respective function. The program may also be program code and/or multiple code segments saved in one or more non-transitory computer readable media (for example, memory media and/or other forms of storage). The program may also be split and saved in multiple non-transitory computer readable media residing in physically discrete devices. The program code or code segments may represent procedures, functions, subprograms, routines, subroutines, modules, software packages, classes, or any combination of instructions, data structures, or program statements. The program code or code segments may be connected to other code segments or hardware circuitry by sending and receiving information, data, arguments, parameters, or memory contents. The program according to an exemplary embodiment of the present application may also be provided as a program product.

In the exemplary embodiments above, the term “processor” is broad enough to encompass one processor or plural processors in collaboration which are located physically apart from each other but may work cooperatively. The order of operations by the processor is not solely limited to the order described in the exemplary embodiments above, and may be changed, as appropriate.

The “system” in the exemplary embodiments refers to both a configuration formed by multiple devices and a configuration formed by a single device.

[Exemplary modification] The exemplary embodiment describes a case of applying the present disclosure to an endpoint camera that performs AI processing of captured images inside the camera 10. However, the present disclosure is not limited to such a configuration and is similarly applicable to a configuration in which image analysis is performed by performing AI processing outside the camera that is the image capture device.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system comprising a processor configured to:
determine a scope of disclosure that determines to what extent personally identifiable information is to be included in information extracted from a captured image, according to a personal information protection level, which depends on an installation location of a camera that continuously captures images of a preset location, and an urgency of an emergency situation that has occurred; and
transmit, to an external device, information extracted from an image captured by the camera with personally identifiable information included according to the determined scope of disclosure.
   (((2)))

The information processing system according to (((1))), further comprising a memory, wherein:
the memory is configured to store the scope of disclosure in association with a combination of a personal information protection level, which depends on the installation location of the camera, and an urgency of an emergency situation that has occurred, and
the processor is configured to determine the scope of disclosure by using the personal information protection level that depends on the installation location of the camera and the urgency of an emergency situation that has occurred.
   (((3)))

The information processing system according to (((2))), wherein:
the scope of disclosure is set such that the higher the personal information protection level, the narrower the scope of personal information to be included in information extracted from an image captured by the camera, and the higher the urgency of the emergency situation, the broader the scope of personal information to be included in information extracted from an image captured by the camera.
   (((4)))

The information processing system according to (((2))), wherein:
the scope of disclosure is set such that, as the scope of personal information to be included in information extracted from an image captured by the camera gets broader, the scope of disclosure gets broader gradually in the following order: skeletal information about a person in a captured image obtained by performing skeletal estimation of the person; identification information of only persons who have consented in advance to providing personal information; and identification information of both persons who have consented in advance to providing personal information and persons who have not.
   (((5)))

The information processing system according to any one of (((1))) to (((4))), wherein:
if an emergency situation occurs in which information extracted from a captured image is not transferable to a preset destination, the processor is configured to input information extracted from an image captured by the camera into a large language model that converts inputted information into text information and outputs the text information, and thereby acquire text information pertaining to image content of the captured image, and
output the acquired text information as speech information via a speech outputter.
   (((6)))

The information processing system according to (((5))), wherein:
the processor is configured to perform skeletal estimation of a person in a captured image to detect whether or not the person is in an abnormal pose,
if an emergency situation occurs in which information extracted from a captured image is not transferable to a preset destination and a person in the image is detected to be in an abnormal pose, the processor is configured to input information extracted from an image in which the person is detected to be in an abnormal pose into the large language model and thereby acquire text information pertaining to the state of the person in the captured image, and
output the acquired text information as speech information via the speech outputter.
   (((7)))

A program causing a computer to execute a process comprising:
determining a scope of disclosure that determines to what extent personally identifiable information is to be included in information extracted from a captured image, according to a personal information protection level, which depends on an installation location of a camera that continuously captures images of a preset location, and an urgency of an emergency situation that has occurred; and
transmitting, to an external device, information extracted from an image captured by the camera with personally identifiable information included according to the determined scope of disclosure.

What is claimed is:

1. An information processing system comprising:
a processor configured to:
determine a scope of disclosure that determines to what extent personally identifiable information is to be included in information extracted from a captured image, according to a personal information protection level, which depends on an installation location of a camera that continuously captures images of a preset location, and an urgency of an emergency situation that has occurred; and
transmit, to an external device, information extracted from an image captured by the camera with personally identifiable information included according to the determined scope of disclosure.

2. The information processing system according to claim 1, further comprising a memory, wherein:
the memory is configured to store the scope of disclosure in association with a combination of a personal information protection level, which depends on the installation location of the camera, and an urgency of an emergency situation that has occurred, and
the processor is configured to determine the scope of disclosure by using the personal information protection level that depends on the installation location of the camera and the urgency of an emergency situation that has occurred.

3. The information processing system according to claim 2, wherein:
the scope of disclosure is set such that the higher the personal information protection level, the narrower the scope of personal information to be included in information extracted from an image captured by the camera, and the higher the urgency of the emergency situation, the broader the scope of personal information to be included in information extracted from an image captured by the camera.

4. The information processing system according to claim 2, wherein:
the scope of disclosure is set such that, as the scope of personal information to be included in information extracted from an image captured by the camera gets broader, the scope of disclosure gets broader gradually in the following order: skeletal information about a person in a captured image obtained by performing skeletal estimation of the person; identification information of only persons who have consented in advance to providing personal information; and identification information of both persons who have consented in advance to providing personal information and persons who have not.

5. The information processing system according to claim 1, wherein:
if an emergency situation occurs in which information extracted from a captured image is not transferable to a preset destination, the processor is configured to input information extracted from an image captured by the camera into a large language model that converts inputted information into text information and outputs the text information, and thereby acquire text information pertaining to image content of the captured image, and
output the acquired text information as speech information via a speech outputter.

6. The information processing system according to claim 5, wherein:
the processor is configured to perform skeletal estimation of a person in a captured image to detect whether or not the person is in an abnormal pose,
if an emergency situation occurs in which information extracted from a captured image is not transferable to a preset destination and a person in the image is detected to be in an abnormal pose, the processor is configured to input information extracted from an image in which the person is detected to be in an abnormal pose into the large language model and thereby acquire text information pertaining to the state of the person in the captured image, and
output the acquired text information as speech information via the speech outputter.

7. An information processing method comprising:
determining a scope of disclosure that determines to what extent personally identifiable information is to be included in information extracted from a captured image, according to a personal information protection level, which depends on an installation location of a camera that continuously captures images of a preset location, and an urgency of an emergency situation that has occurred; and
transmitting, to an external device, information extracted from an image captured by the camera with personally identifiable information included according to the determined scope of disclosure.

8. A non-transitory computer readable medium storing a program causing a computer to execute a process comprising:
determining a scope of disclosure that determines to what extent personally identifiable information is to be included in information extracted from a captured image, according to a personal information protection level, which depends on an installation location of a camera that continuously captures images of a preset location, and an urgency of an emergency situation that has occurred; and
transmitting, to an external device, information extracted from an image captured by the camera with personally identifiable information included according to the determined scope of disclosure.
